(19) United States
(12) Patent Application Publication
(10) Pub. No.: US 2025/0189822 A1
(43) Pub. Date: Jun. 12, 2025

(54) A METHOD TO DESIGN TORIC CONTACT LENSES

(71) Applicants: Nthalmic Holding Pty Ltd, Sydney, New South Wales (AU); VIZIONFOCUS INC., Miaoli County (TW)

(72) Inventor: Klaus Ehrmann, Sydney, New South Wales (AU)

(73) Assignees: Nthalmic Holding Pty Ltd, Sydney, New South Wales (AU); VIZIONFOCUS INC., Miaoli County (TW)

(21) Appl. No.: 18/844,041

(22) PCT Filed: Mar. 6, 2023
(86) PCT No.: PCT/AU2023/050147

§ 371 Date: Sep. 4, 2024

(30) Foreign Application Priority Data
Mar. 9, 2022 (AU) 2022900568

(51) Int. Cl. G02C 7/02; G02C 7/04

(52) U.S. Cl. CPC G02C 7/028; G02C 7/044; G02C 7/048

(57) ABSTRACT

The current disclosure relates to methods of designing a front surface toric soft contact lens with a substantially circular optic zone. More specifically, this disclosure describes a method to design a front surface toric soft contact lens which features a substantially circular optic zone with smooth transitions between the optic zone and the peripheral non-optical stabilisation carrier zone. The optic zone diameter is designed independent of the cylinder power and the shape, or curvature, of the back surface. This disclosure describes a method to design a front surface toric soft contact lens such that neither the edge profile nor the optic zone diameter is affected by the magnitude of cylinder power or the orientation of the cylinder axis.

### FIELD OF THE INVENTION

The current disclosure relates to methods of designing a front surface soft toric contact lens with a circular optic zone. This disclosure describes a method to design a front surface soft toric contact lens that features a circular optic zone with smooth transitions between the circular optic zone and the non-optical peripheral stabilisation carrier zone. The circular optic zone diameter is designed independently of the cylinder power and the shape, or curvature, of the back surface. This disclosure describes a method to design a front surface toric soft contact lens such that neither the edge profile nor the optic zone diameter is affected by the magnitude of the sphere power, the magnitude of the cylinder power and/or the orientation of the cylinder axis.

### BACKGROUND

Astigmatism is one of the refractive errors of the eye caused by a deviation from spherical curvatures of either the cornea and/or the crystalline lens of the eye, which results in distorted images on the retina as the light rays from the object do not converge to a common focal point, but rather to a line of focus.

Astigmatism can occur in combination with other refractive errors, for example, myopia, hyperopia or presbyopia, and affects, to some degree, a large percentage of the population. A cylindrical optical correction, also known as a toric optical correction, may be utilised to correct astigmatism. Accordingly, an individual with myopia or hyperopia, as well as astigmatism, can be fitted with a single soft contact lens that comprises both spherical and cylindrical components within the optic zone.

A toric optical correction or a cylindrical optical correction involves the use of optical features, with the optic zone of the contact lens having two different target powers along two orientations that are perpendicular to one another. Essentially, a toric lens has one power, known as the spherical power, for the correction of the myopic or hyperopic component of the refractive error and a second power, known as the cylinder power, for the correction of the astigmatic component, of which both powers are built into a single optical region of the optic zone of the contact lens.

In general, the toric power of the lens can be generated by continuously changing radii of curvatures either on the front or back surface of the lens or both, between meridional angles. Although most prior art toric soft contact lenses are back surface toric contact lenses, some commercially available front surface toric soft contact lenses exist, which are often prescribed for eyes with predominantly lenticular astigmatism.

For back surface toric soft contact lenses, the smallest radius of curvature is referred to as the steep meridian and the largest radius of curvature is referred to as the flat meridian of the back surface toric soft contact lens. By convention, the orientation of the flat meridian, the meridian with the most plus power, is used to identify the axis of the astigmatic orientation of the back surface toric soft contact lens.

Conversely, for front surface toric soft contact lenses, the toric power of the lens is generated by continuously changing radii of curvatures on the front surface, in which case the abovementioned convention is reversed, i.e., the flat meridian is the meridian with the least plus power.

To achieve the desired toric correction, the orientation of the lens' cylinder axis needs to be aligned with the astigmatic axis of the eye. The toric optical correction is utilised in spectacles, contact lenses and intraocular lens modes of correction. The toric optical correction used in spectacle lenses and intraocular lenses are held fixed relative to the eye. However, contact lenses without any stabilisation features naturally rotate on the eye. Accordingly, toric contact lenses should include a mechanism to rotate the lens in the correct orientation and then keep the contact lens relatively stable on the eye when the wearer blinks or looks around whilst wearing the said toric contact lenses.

The mechanical characteristics of the non-optical peripheral carrier zone of the toric soft contact lens are altered to maintain the on-eye orientation of the toric soft contact lens. For example, the use of a truncated prism, prism ballast, or the utility of purposeful thickening of the periphery of the toric soft contact lens in the inferior region may contribute to better on-eye stabilisation of the toric contact lens. Such methods are described in the following prior art references, the US patents and patent applications, U.S. Pat. No. 10,747,021B2, U.S. Pat. No. 6,626,534B1, U.S. Pat. No. 8,814,350B2, and U.S. Pat. No. 8,646,908B2.

Other stabilisation methods include double slab off designs or peri-ballast soft toric contact lenses. A common feature of all these designs is a rotationally symmetric peripheral back surface, with the peripheral thickness variations being achieved by a rotationally asymmetric peripheral front surface. Traditionally, back surface toric soft contact lenses with astigmatic correction have an optic zone that is elliptical in shape, whereby the longest axis corresponds to the meridian with the most positive power and the shortest axis corresponds to the meridian with the least positive power. For higher cylinder powers, for example, a cylinder power greater than −3.00 DC, this difference between the steep and the flat meridian, i.e., the ellipticity of the optic zone, becomes rather large, making it difficult to maintain either an optic zone diameter that can provide adequate pupil coverage or a peripheral thickness profile that can provide good comfort and on-eye orientation stability.

There is a need in the art for a new design method that facilitates maintaining a circular optic zone of a suitable diameter for any given magnitude of sphere and cylinder power and any orientation of the cylindrical axis.

### SUMMARY OF THE INVENTION

Certain methods and algorithms of the current disclosure are directed to designing front surface toric soft contact lenses for the correction of distance vision that maintain a circular, front optic zone of a suitable diameter for any given magnitude of sphere and cylinder power and any orientation of the cylindrical axis.

Other methods and algorithms of the current disclosure are directed to designing front surface multifocal toric soft contact lenses for the correction of distance and near vision that maintain a circular front optic zone of a suitable diameter for any given magnitude of sphere, cylinder and Add power and any orientation of the cylindrical axis.

In this disclosure, the term “front surface toric soft contact lens” means a contact lens that corrects distance vision, i.e., myopia or hyperopia with astigmatism.

The term “front surface multifocal toric soft contact lens” means a front surface toric soft contact lens of the current disclosure designed for a presbyopic eye that provides correction for distance and near vision as well as astigmatism. In this disclosure, the described methods relating to designing the front surface toric soft contact lenses are also applicable to designing front surface multifocal toric soft contact lenses. The method of designing front surface multifocal toric soft contact lenses are deemed to be fully within the scope of the current invention of designing front surface toric soft contact lenses.

One of the preferred methods of designing a front surface toric soft contact lens embodiment of the current disclosure may be based on an algorithm that includes, at least in part, a series of following steps: (a) define a specific magnitude of a cylinder power and a specific orientation of a cylinder axis for the front surface toric soft contact lens; (b) define a specific optic zone diameter for the front surface toric soft contact lens; (c) define a back surface shape for the front surface toric soft contact lens across the lens diameter, wherein the back surface shape may be defined by a spherical or an aspherical curve or a multitude or combination of both joined with or without blending; (d) define a centre thickness for the front surface toric soft contact lens; (e) calculate a required power profile for each half-meridian within the optic zone of the front surface toric soft contact lens that is based on the specified magnitude of the cylinder power and the orientation of the cylinder axis; wherein the power profile along each half-meridian of the optic zone of the front surface toric soft contact lens may be defined with or without spherical aberration, wherein the sign of spherical aberration within the optic zone may be positive or negative and wherein the magnitude of spherical aberration within the optic zone is between 0 D and 2 D; (f) using the defined half-meridian power profiles, the centre thickness and the refractive index of the front surface toric soft contact lens, calculate the thickness profile for each of the half-meridians of the optic zone of the front surface toric soft contact lens; (g) add the thickness profiles defined along each half-meridian to the back surface profile, thereby generating the front optic surface shape within the specified front optic zone diameter; (h) define the thickness profiles of the peripheral non-optical stabilisation zone along the corresponding half-meridians; (i) define a blending zone along each half-meridian to join, substantially smoothly, the optic zone with the peripheral non-optical stabilisation zone of the front surface of the front surface toric soft contact lens; (j) define an edge profile; and (k) using an existing lathing technology platform, for example, the state of the art computer number control (CNC) lathe technology, to generate a front surface with the required precision to obtain good optical quality surfaces and smooth transitions without the need for polishing. According to the disclosure, the plurality of specified half-meridians of the optic zone of the front surface toric soft contact lens may be selected such that it can range between approximately 12 and approximately 400 half-meridians. According to the disclosure, by calculating the front surface shape based on thickness profiles of the optic zone of the front surface toric soft contact lens, the back surface design of the front surface toric soft contact lens is not constrained by the requirement to accommodate the long and short axis within the peripheral non-optical stabilisation zone. For example, one distinct advantage of this disclosure is that an aspheric or multicurve back surface can be used with asphericity values (p-values) of less than 1, i.e., flattening towards the periphery. In some other examples, asphericity may be represented as Q or k. The method described herein can be applied to both lathe-cut and cast-moulded modes of manufacturing front surface toric soft contact lenses.

Certain methods and algorithms of the current disclosure are directed to designing front surface toric soft contact lenses that offer two distinct advantages over the conventional back surface toric soft contact lens design methods; (a) allowing to maintain a circular optic zone of a suitable diameter that can be maintained across all sphere, cylinder and axis prescriptions of the front surface toric soft contact lens; and/or (b) allowing the blending between the optic zone and the non-optical peripheral stabilisation zone to be optimised for each half-meridian and for each individual prescription for the front surface toric soft contact lens.

Another preferred method of designing a front surface toric soft contact lens embodiment of the current disclosure may be based on another algorithm that includes, at least in part, a series of the following steps: (a) define a specific magnitude of a cylinder power and a specific orientation of a cylinder axis for the front surface toric soft contact lens; (b) define a specific optic zone diameter for the front surface toric soft contact lens; (c) define a rotationally symmetric back surface shape for the front surface toric soft contact lens, wherein the rotationally symmetric back surface shape may be defined by a single aspheric curve or a multi-curve defined by a set of spheres and/or aspheres; (d) if the back surface is defined as a set of multi-curve aspheres then define a back optic zone diameter that is preferably similar or larger than the front optic zone diameter of the front surface toric soft contact lens; (e) define a total lens diameter of the front surface toric soft contact lens; (f) select a plurality of half-meridians within the optic zone of the front surface toric soft contact lens for defining the front surface; wherein the suitable plurality of half-meridians within the optic zone of the front surface toric soft contact lens may be approximately between 12 and 400 half-meridians; (g) for each half-meridian within the optic zone of the front surface toric soft contact lens, calculate the required power profile based on the lens prescription of the specific magnitude of sphere, cylinder power and axis, and the required magnitude and sign of spherical aberration to be included within the optic zone; (h) select a lens material with known refractive index and expansion properties; (i) select a suitable central thickness for the front surface toric soft contact lens; (j) define the circular diameter for the front optic zone of the front surface toric soft contact lens; (k) based on the refractive index of the material and the centre thickness, calculate the radial or axial thickness profile along each half-meridian that will achieve the desired refractive power within the front optic zone diameter of the front surface toric soft contact lens; wherein the radial or axial thickness profiles may be defined with discrete data points along the half-meridian of suitable density. In this step (k), for the front surface toric soft contact lens designed with prism ballast stabilisation, it may be advantageous to add a matching prismatic thickness differential to each of the half-meridians of the front surface toric soft contact lens; (I) define the desired thickness profile for the peripheral non-optical stabilisation zone along each half-meridian of the front surface toric soft contact lens; (m) define the blending width between the front optic zone of the front surface toric soft contact lens and the peripheral non-optical stabilisation zone along each half-meridian of the front surface toric soft contact lens; (n) apply a suitable blending algorithm to join these two zones substantially smoothly along each half-meridian of the front surface toric soft contact lens; (o) add the thickness profiles along each half-meridian to the back surface of the front surface toric soft contact lens to obtain the front surface data points; (p) add a suitable edge profile to the front and back surface profiles of the front surface toric soft contact lens; wherein the edge profile is defined independent of magnitude of cylinder power and independent of the orientation of the cylinder axis and (q) transform the front and back surface data points into a format that is suitable for manufacturing respective surfaces of the front surface toric soft contact lens.

In some embodiments of the disclosure, where the contact lens is a front surface multifocal soft contact lens, one or more steps of a preferred exemplary method of the disclosure also include defining a specific magnitude of the Add power for a front surface multifocal soft contact lens and to calculate the required power profile based on the lens prescription of the specific magnitude of sphere, cylinder power, Add power and cylinder axis, and the required magnitude and sign of spherical aberration to be included within the optic zone.

In some embodiments of the disclosure, one or more steps of a preferred exemplary method of the disclosure may be combined with one or more steps of another preferred exemplary method of the disclosure, and the resultant steps of such a combination may be considered another preferred exemplary method of the disclosure that is within the scope of the current invention.

### BRIEF DESCRIPTION OF THE FIGURES

FIG. 1 is a representation of a frontal view of a back surface toric soft contact lens of the prior art with a non-circular optic zone.

FIG. 2 is a representation of a frontal view of a front surface toric soft contact lens of the current disclosure with a substantially circular optic zone surrounded by a blending zone of variable width.

FIG. 3 is a representation of a cross-sectional view of the back surface of a front surface toric soft contact lens embodiment of the current disclosure defined using two exemplary steps; (a) the back surface defined using a single-curve asphere and a lens diameter or a semi-diameter, as disclosed herein.

FIG. 4 is another representation of a cross-sectional view of the back surface of a front surface toric soft contact lens embodiment of the current disclosure defined using three exemplary steps; (a) the back surface defined using a multi-curve set of aspheres; (b) a back optic zone semi-diameter; and (c) a lens diameter or a semi-diameter, as disclosed herein.

FIG. 5 is a representation of a frontal view of the optic zone diameter of a front surface toric soft contact lens embodiment of the current disclosure, wherein the step of selecting a plurality of half-meridians about the front optic zone semi-diameter of the front surface toric soft contact lens is exemplified, as disclosed herein.

FIG. 6 is a representation of a cross-sectional view of the optic zone semi diameter of a front surface toric soft contact lens embodiment of the current disclosure; wherein the step of defining power profiles for the selected plurality of half-meridians about the front optic zone semi-diameter of the front surface toric soft contact lens is exemplified, as disclosed herein.

FIG. 7 is a representation of a cross-sectional view of the semi diameter of a front surface toric soft contact lens embodiment of the current disclosure; wherein the step of defining blending zone width and selection of blending curves to provide substantially junction free or smooth profiles between the selected plurality of half-meridians about the front optic zone semi-diameter and the selected plurality of peripheral non-optical stabilisation zone thickness profiles of the front surface toric soft contact lens is exemplified, as disclosed herein.

FIG. 8 is a representation of a cross-sectional view of the semi diameter of a front surface toric soft contact lens embodiment of the current disclosure; wherein the step of generating the front surface sag profiles for the selected plurality of half-meridians about the front semi-diameter of the front surface toric soft contact lens is exemplified, as disclosed herein.

FIG. 9 shows the front surface sag profile data for three selected half-meridians of a front surface toric soft contact lens of the current disclosure.

FIG. 10 shows a 3D radial thickness profile of a front surface toric soft contact lens with a prescription of (−3 D/−2.5 DC×60° that is designed using methods of the prior art.

FIG. 11 shows a 3D radial thickness profile of a front surface toric soft contact lens with a prescription of (−3D/−2.5 DC×60° that is designed using methods of the current disclosure.

FIG. 12 shows the cross-sectional radial thickness profile along the vertical meridian of two front surface toric soft contact lenses designed using: (a) methods of the prior art (dotted line); and (b) methods of the current disclosure (solid line).

FIG. 13 is a representation of a frontal view of a centre-near multifocal front surface toric soft contact lens of the current disclosure with substantially circular distance and near optic zones.

FIG. 14 is a representation of a cross-sectional view of the optic zone semi diameter of a centre-near multifocal front surface toric soft contact lens embodiment of the current disclosure; wherein the step of defining power profiles for the selected plurality of half-meridians about the front optic zone semi-diameter of the centre-near multifocal front surface toric soft contact lens is exemplified, as disclosed herein.

### DETAILED DESCRIPTION

In this section, the present disclosure will be described in detail with reference to one or more methods. Some are illustrated and supported by accompanying figures.

The examples and embodiments are provided by way of explanation and are not to be construed as limiting the scope of the current disclosure. The following description is provided in relation to the methods that may share common characteristics and features of the disclosure. It is to be understood that one or more features of one method may be combined with one or more methods of any other embodiment, which may constitute additional method embodiments of the front surface toric soft contact lenses of the current disclosure.

The functional and structural information disclosed herein is not to be interpreted as limiting in any way and should be construed merely as a representative basis for teaching a person skilled in the art to employ the disclosed methods and variations of those methods in various ways to design, develop, manufacture toric soft contact lenses, more specifically front surface toric soft contact lenses.

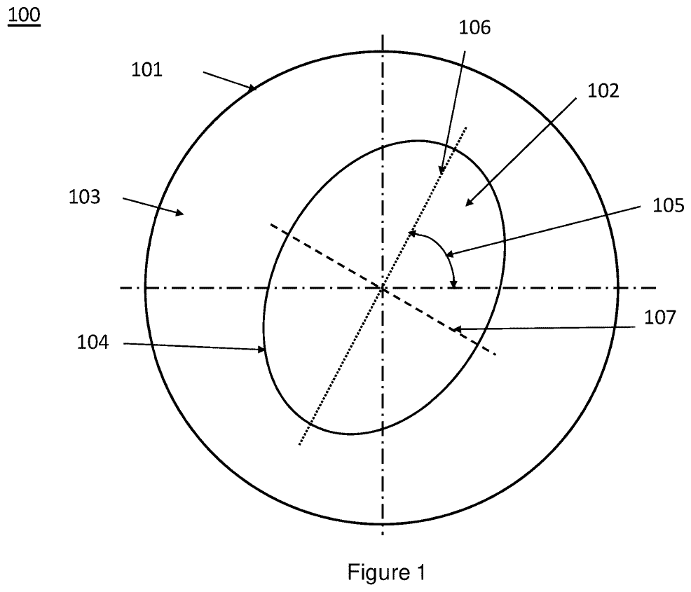

FIG. 1 shows the frontal view of a back surface toric soft contact lens (100) of the prior art that is configured of a lens diameter (101), a non-circular optic zone (102) and a peripheral non-optical stabilisation zone (103). The transition (104) between the non-circular optic zone (102) and the peripheral non-optical stabilisation zone (103) of the back surface toric soft contact lens (100) has no defined blending, which can result in compromised performance with respect to comfort and/or vision as the lens may not stabilise as required.

The elliptical shape and size of the non-circular optic zone (102) of the back surface toric soft contact lens (100) is in proportion to its toric prescription, i.e., the spherical power, the cylinder power and the cylinder axis. The long axis of the ellipse (106) represents the meridian with the largest radius of curvature and the most plus power. Its orientation defines the cylinder axis (105), which in this example is about 60°. The short axis of the ellipse represents the meridian with the smallest radius of curvature, or the meridian with the most minus power, or the steep meridian (107). The cylinder power of the lens is the power difference between the flat meridian (106) and the steep meridian (107). As the eccentricity or the ratio between the length of the short and long axis of the ellipse or the non-circular optic zone (102) of the back surface toric soft contact lens (100) increases with increasing cylinder power, a further deterioration of performance, particularly for oblique cylinder axes, can occur.

Whilst FIG. 1 provides an example of a back surface toric soft contact lens (100) of the prior art, the same design limitations are also present for front surface toric soft contact lenses of the prior art.

To overcome the design limitations of front or back surface toric soft contact lenses with non-circular optic zones of the prior art, a novel method for designing front surface toric soft contact lenses is provided to offer a circular optic zone irrespective of the toric prescription, that is independent of the magnitude of the cylinder power and independent of the orientation of the axis of the cylinder.

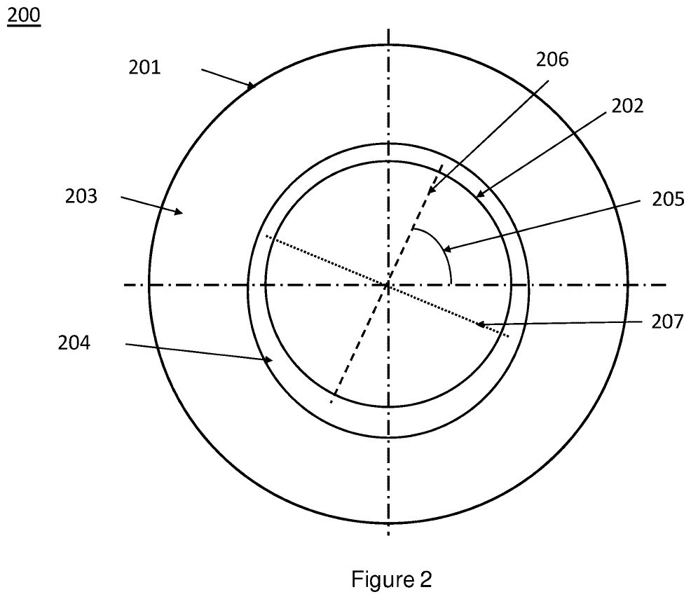

FIG. 2 shows the frontal view of a front surface toric soft contact lens (200) of the current disclosure that is configured of a lens diameter (201), a substantially circular optic zone (202), a peripheral non-optical stabilisation zone (203) and a blending zone (204) between the substantially circular optic zone (202) and the peripheral non-optical stabilisation zone (203). The blending zone (204) provides smooth blending, which can result in improved performance with respect to comfort and/or vision, when compared to current prior art front surface toric soft contact lenses.

The substantially circular optic zone (202) of the front surface toric soft contact lens (200) comprises of a meridian with the smallest radius of curvature, which is also the meridian with the most plus power, or the steep meridian (206), and a meridian with the largest radius of curvature, or the meridian with the least plus power, or the flat meridian (207). In this embodiment, the orientation of the steep meridian (206) defines the cylinder axis (205), which in this example is about 60°. The cylinder power of the lens is the power difference between the steep meridian (206) and the flat meridian (207). As the cylinder power increases, the size and shape of the substantially circular optic zone (202) remain substantially the same, which can provide visual performance that is independent of the toric prescription.

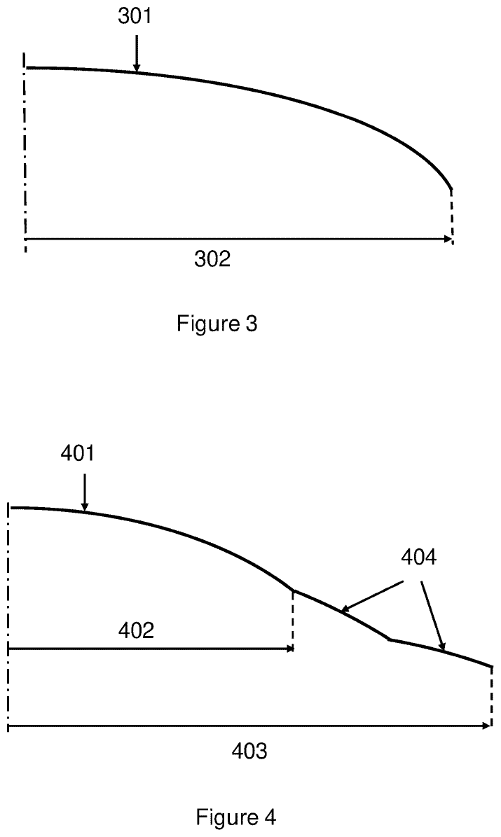

The first few steps of the exemplary method of the current disclosure are described in FIG. 3, which represents a cross-sectional view of the back surface of a front surface toric soft contact lens embodiment of the current disclosure. In this example, the first step is to define the back surface of the front surface toric soft contact lens using a single-curve asphere (301) over a defined lens diameter or a semi-diameter (Step 2, 302), as disclosed herein.

In an alternative embodiment, the first few steps of the exemplary method of the current disclosure are described in FIG. 4, which is a representation of a cross-sectional view of the back surface of a front surface toric soft contact lens embodiment.

In this example, the first step is to define the central back surface using a spherical or aspherical curve (401), including specifications for the central back optic zone semi-diameter (402). Step 3 includes defining the lens semi-diameter (403) and at least one back peripheral curve (404). Appropriate blending may be applied between these zones (401 and 404) to smoothen any sharp junctions.

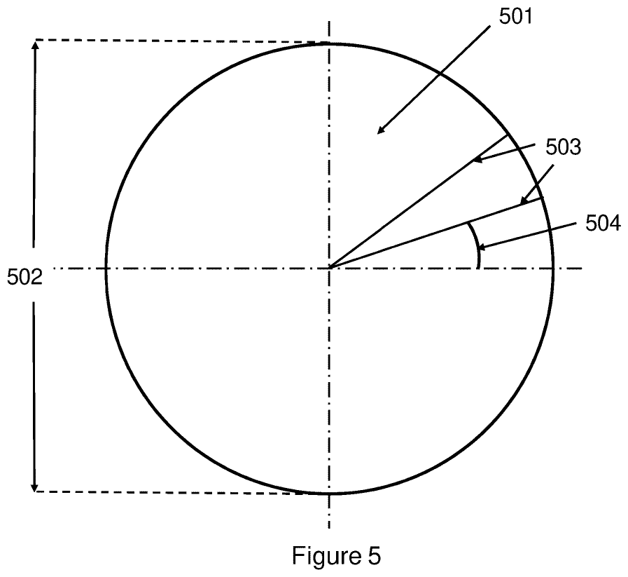

Step 4 of the exemplary method of the current disclosure is described in FIG. 5, which is a representation of a frontal view of the optic zone (501) of diameter (502) of a front surface toric soft contact lens embodiment of the current disclosure; wherein the step includes a selection of a plurality of half-meridians (503) about the front optic zone diameter (502) of the front surface toric soft contact lens, preferably in equal increments around the clock, separated by angle theta (504), as disclosed herein.

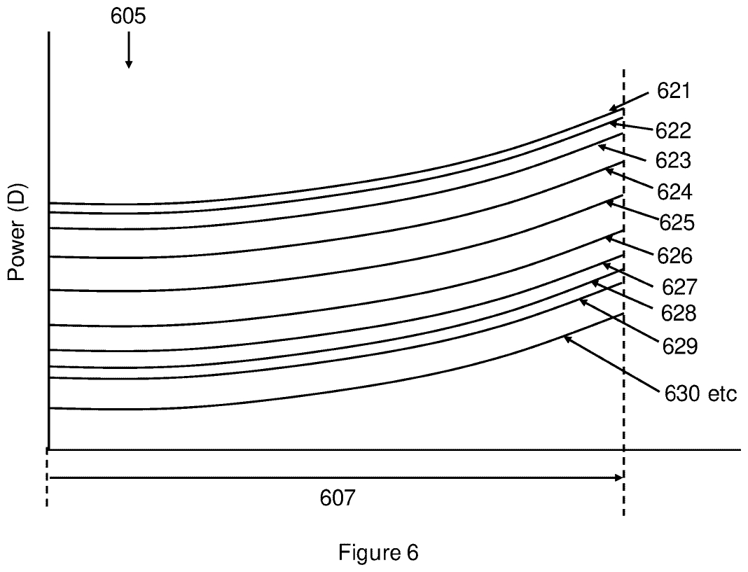

The next step of the exemplary method of the current disclosure is Step 5 (605) as described in FIG. 6, which is a representation of the power profiles within the substantially circular optic zone of a front surface toric soft contact lens embodiment of the current disclosure; wherein this step involves defining power profiles for the selected plurality of half-meridians within the front optic zone as disclosed herein. In FIG. 6, the power profiles for various half-meridians (621 to 630, etc.) are plotted for individual angles theta as a function of front optic zone semi diameter (607) (i.e., the distance away from the centre). In some embodiments, the selected plurality of half-meridians may be between 12 and 400 half-meridians, or 10 and 300 half-meridians, or 8 and 240 half-meridians. In some embodiments of the current disclosure, the power difference between the least positive (630) and the most positive (621) half meridian, also known as the cylinder power, may be between 0.25 DC and 5 DC, between 0.5 DC and 3 DC, between 0.5 DC and 6 DC, or between 1 DC and 4 DC. In other embodiments of the current disclosure, the power difference between the least positive (630) and the most positive (621) half meridian, also known as the cylinder power, may be at least 0.25 DC, at least 1 DC, at least 3 DC or at least 4 DC. In some embodiments of the current disclosure, the power profile across a selected half-meridian may be configured spherical, aspherical or as a multicurve.

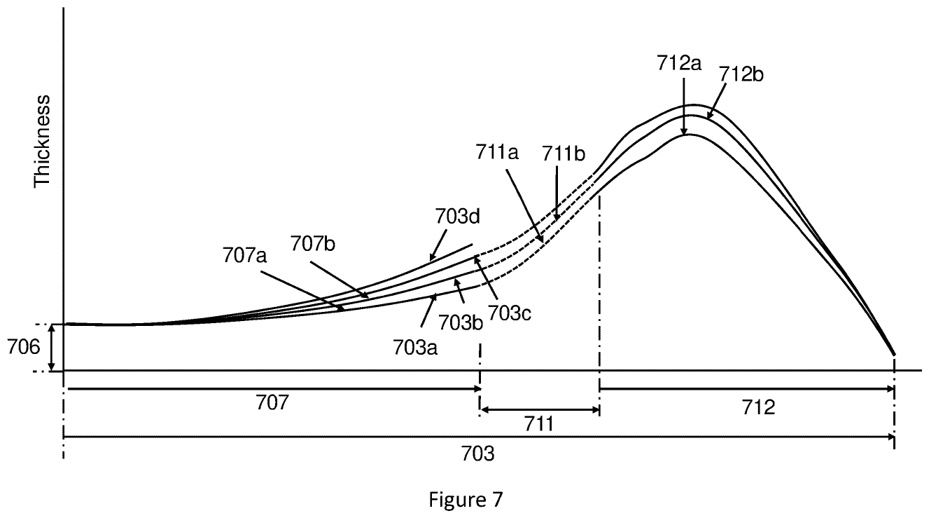

Another set of steps of the exemplary method of the current disclosure is described in FIG. 7, which is a representation of thickness profiles (703a, 703b, 703c, 703d etc) along the semi diameter (703) of a front surface toric soft contact lens embodiment of the current disclosure; wherein the steps include or involve, Step 6 selecting a centre thickness (706), Step 7 converting the half-meridional power profiles (621 to 630) into half-meridional thickness profiles (e.g., 707a and 707b) of the front optic zone semi diameter (707) under consideration of the contact lens material refractive index, if required, add a matching prismatic thickness differential to each of the selected half-meridional thickness profiles (e.g., 707a and 707b) of the front optic zone semi diameter (707), Step 9 defining blending zone width (711), Step 10 defining peripheral thickness profiles (e.g., 712a and 712b) for each of the peripheral zone selected half-meridians (712) and Step 11 selection of the shape of the blending curves (e.g., 711a and 711b) to provide a substantially junction-free or smooth profile between the selected plurality of half-meridians (e.g., 707a and 707b) about the front optic zone semi-diameter (707) and the selected plurality of peripheral zone thickness profiles (e.g., 712a and 712b) of the front surface toric soft contact lens, as disclosed herein. The blending width may vary between half meridians by extending zone 711 and shortening peripheral zone 712 or vice versa.

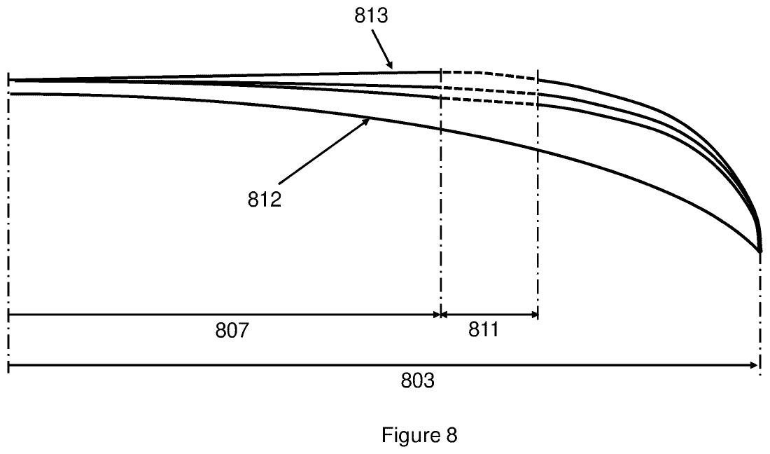

The final step of the exemplary method of the current disclosure is described in FIG. 8, which is a representation of a cross-sectional view of the semi diameter of a front surface toric soft contact lens embodiment of the current disclosure; wherein the step includes, or involves, generation of the front surface sag profiles (813) for the selected ‘n’ plurality of half-meridians about the semi-diameter of the front surface toric soft contact lens by adding the thickness profiles of the optic zone (707), the blending zone (711) and the peripheral zone (712) to the back surface profile (812), as disclosed herein.

A preferred exemplary method of designing a front surface toric soft contact lens, as per the embodiments of the current disclosure, may be based on another algorithm that includes, at least in part, a series of the following steps: (Step 1) define a rotationally symmetric back surface profile for the front surface toric soft contact lens; wherein the said rotationally symmetric back surface could either be designed as a single-curve asphere or a multi-curve set of conic sections. Execute (Step 2) if required, that is if the rotationally symmetric back surface profile for the front surface toric soft contact lens is defined as a multi-curve, then define the back optic zone diameter such that it is preferably similar or larger than the front optic zone diameter of the front surface toric soft contact lens. (Step 3) Define the front surface toric soft contact lens diameter (or the semi-diameter) and suitable back peripheral curves to achieve the targeted average base curve. (Step 4) Select a front optic zone diameter and a plurality of half-meridians for the front surface definition of the optic zone of the front surface toric soft contact lens. For example, the plurality of half-meridians may be between 12 and 400. (Step 5) In this example, for each half-meridian of the optic zone, calculate the required power profile based on the toric lens prescription of a sphere, a cylinder power, a cylinder axis and a spherical aberration. (Step 6) Select the lens material, and a suitable centre thickness. (Step 7) Convert the plurality of half-meridional power profiles into thickness profiles based on the selected material refractive index and centre thickness. (Step 8) Define the blending width between the front optic zone and the front non-optical peripheral stabilisation zone. (Step 9) Define the peripheral thickness profiles for each half meridian. (Step 10) Apply blending curves along each half meridian to smoothly join the optic zone thickness profiles with the peripheral zone thickness profiles. (Step 11) Add the calculated thickness profiles of each half meridian to the back surface to generate the front surface profiles along each half meridian. The choice of peripheral thickness profiles for each of the half meridians is in part defined by the selected stabilisation method. Combining the peripheral thickness profiles along each of the half meridians may constitute one of the commonly used stabilisation methods or prism ballast, peri ballast or dynamic stabilisation, or any other method that can orient the lens on eye. A suitable edge profile may be added to the front and back surface profile to facilitate ease of manufacturing and provide acceptable on-eye comfort. Transform the front and back surface data points into a format that is suitable for manufacturing respective surfaces.

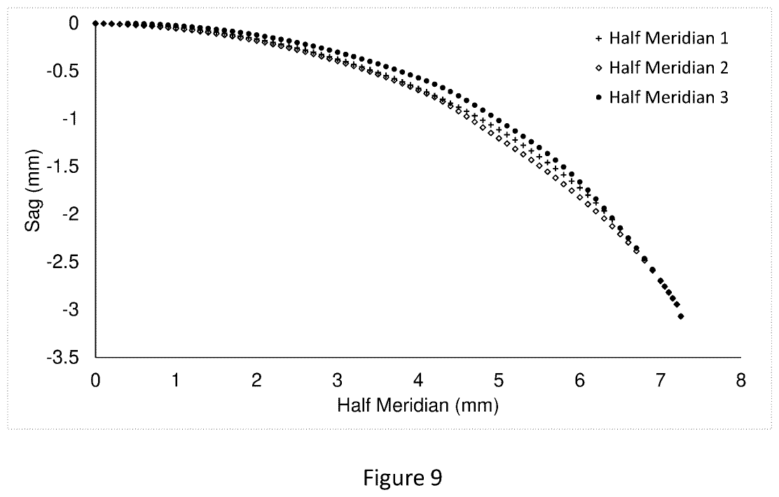

For example, FIG. 9 shows the front surface sag profile data for three selected half-meridians of a front surface toric soft contact lens of the current disclosure that can be used in a lathe for manufacturing the front surface. However, the actual number of half-meridians required for the manufacture of the front surface toric soft contact lens may be between 12 and 400. The density of the data points along the half-meridians can vary. In this example, the data points were denser towards the edge of the lens. In other examples, the density could be the same across the half-meridian.

The front surface toric soft contact lens designed using the method of the current disclosure provides two advantages over the conventional toric soft contact lens design methods; (I) it facilitates a circular optic zone of a suitable diameter that can be maintained across all sphere, cylinder and axis prescriptions of the front toric soft contact lens; and/or (II) it facilitates a blending zone between the optic zone and the non-optical peripheral stabilisation zone which can be optimised for each half-meridian of the front surface toric soft contact lens for each individual prescription for the front surface toric soft contact lens. Smooth surfaces and thickness profiles are considered to be advantages for comfortable on-eye wear.

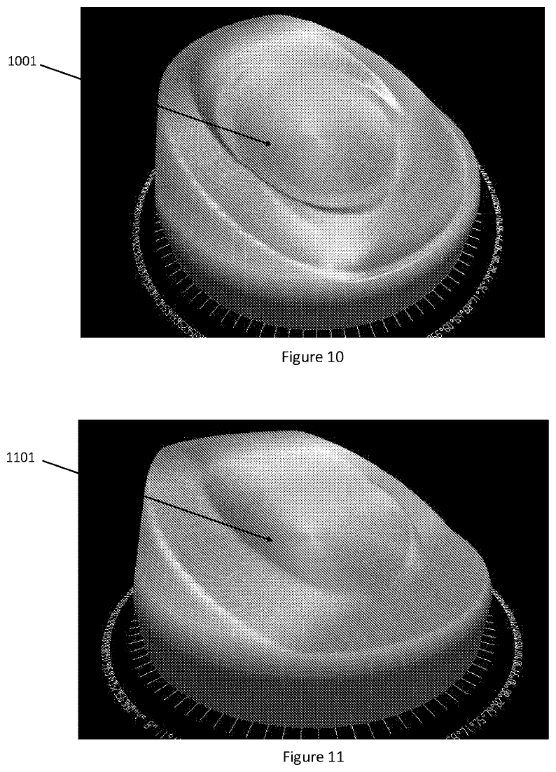

The three-dimensional thickness profile of the front surface toric soft contact lens of the prior art with a prescription of −3.00 DS/−2.50 DC×60 degrees axis is shown in FIG. 10. As can be seen, the prior art method produces a non-circular or oval-shaped optical zone (1001) that may not offer robust visual performance across a range of pupil diameters that may be experienced by the wearer. Further, the greater the magnitude of the cylinder power to be incorporated within the toric soft contact lens, the greater the deviation from a circular optic zone. For cylinder power magnitudes that are greater than 3 DC, the oval optic zone may lead to substantial visual performance issues.

Unlike the teachings of the prior art, the new method of designing a front surface toric soft contact lens offers two distinct advantages, i.e, to maintain the circular-shaped optic zone (1101) irrespective of the magnitude of cylinder power of the front surface toric soft contact lens and to smoothly blend the optical zone with the peripheral non-optical stabilisation zone for improved on-eye comfort. The three-dimensional thickness profile of the front surface toric soft contact lens designed at least in part using the method of the current disclosure is shown in FIG. 11. The front surface toric soft contact lens of FIG. 11 has a prescription of −3.00 DS/−2.50 DC×60 degrees axis.

Commonly, the minimum optical zone diameter of soft contact lenses is about 8 mm, which corresponds to a clinically relevant maximum pupil diameter for scotopic-mesopic lighting conditions. The table below shows the expected changes of the optical zone diameters, i.e., the short and long axes, of a front surface toric soft contact lens of the prior art as the cylinder power increases. For low cylinder powers up to about −2.0 DC, a minimum optical zone diameter of 8 mm can be maintained. However, for higher cylinder powers, the short axis optical zone diameter needs to be reduced as the long axis optical zone diameter would have impinged on the peripheral edge of the soft contact lens which is usually 14 mm in diameter.

Thus, a front surface toric soft contact lens of the prior art with a cylinder power of −4.00 DC, for example, would generate a short axis optical zone diameter of 6.2 mm while the long axis optical zone diameter is maintained at a maximum of 13.6 mm. This short axis optical zone diameter of 6.2 mm would be too small to be acceptable for satisfactory visual performance at all lighting conditions.

| Cylinder Power (in | Diameter of short axis | Diameter of long axis |
|---|---|---|
| Dioptres) | (mm) | (mm) |
| −1.0 | 8.0 | 11.8 |
| −1.5 | 8.0 | 12.8 |
| −2.0 | 8.0 | 13.6 |
| −2.5 | 7.6 | 13.6 |
| −3.0 | 7.0 | 13.6 |
| −3.5 | 6.6 | 13.6 |
| −4.0 | 6.2 | 13.6 |

In contrast, with the new current disclosed method of designing the front surface toric soft contact lens, the optical zone diameter can be kept substantially constant at 8 mm irrespective of the magnitude of the cylinder power.

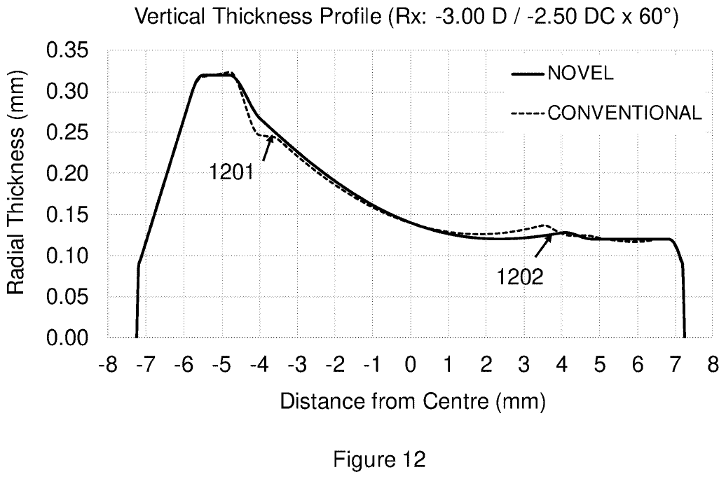

FIG. 12 shows an example of the vertical thickness profiles of a prism ballast toric soft contact lens. The dashed line (1201) represents the radial thickness profile obtained when the lens is designed using conventional front or back surface toric design methods. The solid line (1202) represents the radial thickness profile of the same lens prescription that had been designed in accordance with the disclosed method. As can be seen, the solid line has a smoother profile and maintains an optic zone diameter of approximately 8 mm across both half-meridians. In contrast, the dashed line has more bumps and dips (i.e., undesirable surface undulations), and the optic zone diameter is reduced to approximately 7 mm across this vertical meridian.

Although the exemplary embodiment described as FIG. 12 of this disclosure includes the implementation of a front surface toric design using prism ballast, the disclosed method of designing front surface toric designs can also be configured with various other stabilisation techniques contemplated in the prior art.

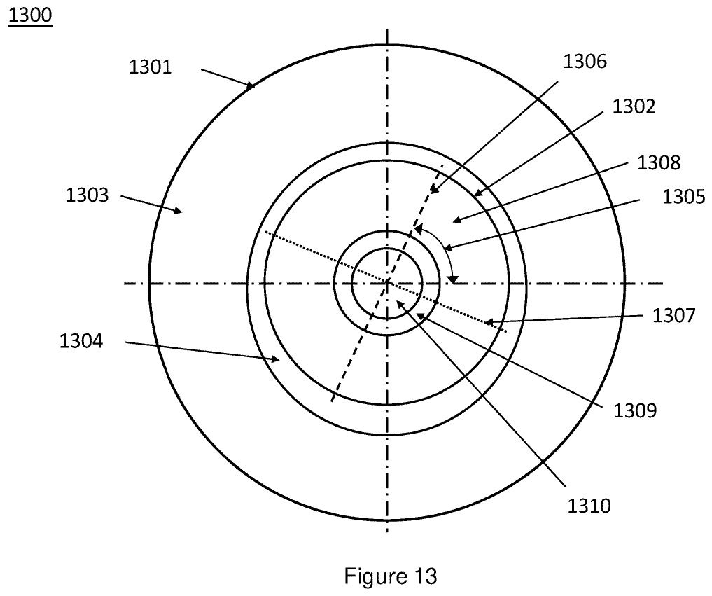

FIG. 13 shows the frontal view of a centre-near multifocal front surface toric soft contact lens (1300) of the current disclosure that is configured with a lens diameter (1301), a substantially circular optic zone (1302), a peripheral non-optical stabilisation zone (1303) and a blending zone (1304) between the substantially circular optic zone (1302) and the peripheral non-optical stabilisation zone (1303). The blending zone (1304) provides smooth blending, which can result in improved performance with respect to comfort and/or vision, when compared to current prior art front surface toric soft contact lenses.

The substantially circular optic zone (1302) of the centre-near multifocal front surface toric soft contact lens (1300) comprises a concentric distance vision zone (1308) and a concentric intermediate vision zone (1309), a centre-near vision zone (1310), a meridian with the smallest radius of curvature, or the meridian with the most plus power, or the steep meridian (1306), and a meridian with the longest radius of curvature, or the meridian with the least plus power, or the flat meridian (1307). In this embodiment, the orientation of the steep meridian (1306) defines the cylinder axis (1305), which in this example is about 60°. The cylinder power of the lens is the power difference between the steep meridian (1306) and the flat meridian (1307). As the cylinder power increases, the size and shape of the substantially circular optic zone (1302) remains substantially the same, which can provide visual performance that is independent of the toric prescription.

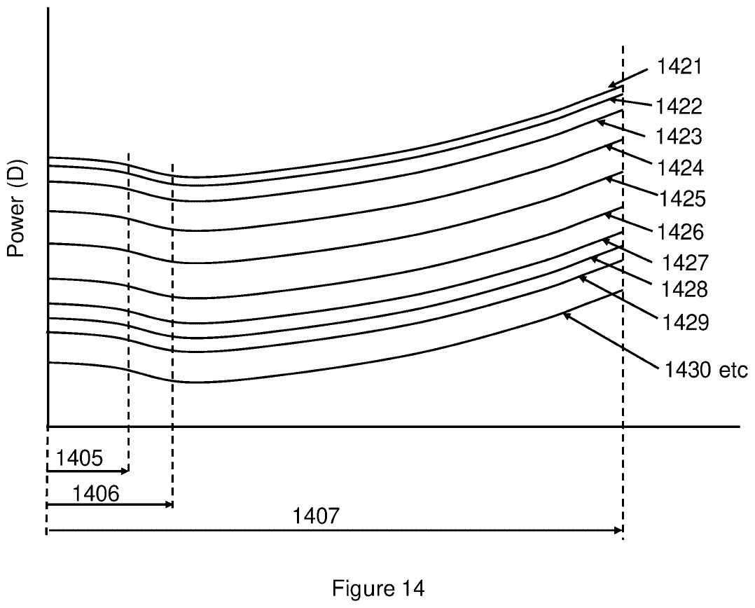

FIG. 14 is a representation of a cross-sectional view of the optic zone semi diameter of a centre-near multifocal front surface toric soft contact lens embodiment of the current disclosure; wherein the step of defining power profiles for the selected plurality of half-meridians about the front optic zone semi-diameter of the centre-near multifocal front surface toric soft contact lens is exemplified, as disclosed herein.

In FIG. 14, the power profiles of the exemplified centre-near multifocal front surface toric soft lens for various half-meridians (1421 to 1430, etc.) are plotted for individual angles theta as a function of front optic zone semi diameter (1407) (i.e., the distance away from the centre). Centre-distance and other power profiles that provide multifocality are also envisaged and are deemed within the scope and spirit of this disclosure. In some embodiments, the selected plurality of half-meridians may be between 12 and 400 half-meridians, or 10 and 300 half-meridians, or 8 and 240 half-meridians. In some embodiments of the current disclosure, the power difference between the least positive (1430) and the most positive (1421) half meridian, also known as the cylinder power, may be between 0.25 DC and 5 DC, between 0.5 DC and 3 DC, between 0.5 DC and 6 DC, or between 1 DC and 4 DC. In other embodiments of the current disclosure, the power difference between the least positive (1430) and the most positive (1421) half meridian, also known as the cylinder power, may be at least 0.25 DC, at least 1 DC, at least 3 DC or at least 4 DC.

The current disclosure describes a multifocal front surface toric soft contact lens (for example FIG. 13), comprising a front surface, a back surface, a centre thickness, a front and back surface optic zone with a plurality of half-meridians and a plurality of power profiles, a peripheral stabilisation zone circumscribing the optic zone, a blending zone between the front optic zone and the peripheral stabilisation zone, and an edge; wherein the multifocal front surface toric soft contact lens is configured utilising a design method; wherein the design method utilises an algorithm that includes, at least in part, a series of design steps: (1) define a diameter for the multifocal front surface toric soft contact lens; (2) define diameters for the optic zones; (3) define a width for the blending zone for each half-meridian; (4) define a width for the peripheral stabilisation zone for each half-meridian; (5) define a rotationally symmetric back surface for the multifocal front surface toric soft contact lens; (6) select a plurality of half-meridians to define the multifocal front surface of the contact lens; (7) calculate a power profile along each of the plurality of half-meridians of the multifocal front surface toric soft contact lens based on a prescription including a sphere power, a cylinder power, an Add power, a cylinder axis and a spherical aberration; (8) select a lens material and a suitable centre thickness for the front surface toric soft contact lens; (9) based on the lens material's refractive index and the centre thickness, calculate the radial or axial thickness profiles along each of the plurality of half-meridians within the optic zone to achieve the power profile, wherein the radial thickness profiles are defined with a plurality of discrete points selected along each of the plurality of the half-meridians within the optic zone; (10) add a desired thickness profile to each of the plurality of half-meridians within the peripheral stabilisation zone; (11) optimise the blending width between the optic zone and the peripheral stabilisation zone for each of the plurality of the half meridians; (12) apply a suitable blending algorithm to join the optic zone and the peripheral zones such that they are substantially smooth along each of the plurality of half-meridians; (13) add the thickness profiles along each of the plurality of half-meridians onto the back surface to obtain the front surface data points; (14) add an edge to the front and back surface profile; and (15) transform the front and back surface data points into a format that is suitable for manufacturing the front and back surfaces.

The utility of this invention enables a contact lens manufacturer to design front surface toric soft contact lenses by adding calculated thickness profiles, exemplified in various examples disclosed herein, to any arbitrary base curve offering the degree of freedom to maintain a circular-shaped optic zone, wherein the shape is independent of the magnitude of cylinder power incorporated within the front surface toric soft contact lens of the current disclosure. More specifically, one method of the current disclosure provides a front surface toric soft contact lens that features an essentially circular-shaped optic zone.

In some embodiments, the front surface toric soft contact lens comprises a front surface, a back surface, a centre thickness, an optic zone with a power profile, a peripheral stabilisation zone circumscribing the optic zone, a blending zone between the optic zone and the peripheral stabilisation zone, and an edge; wherein the contact lens is configured utilising a design method; wherein the design method utilises an algorithm that includes, at least in part, a series of design steps: (1) define a diameter for the contact lens; (2) define a diameter for the optic zone; (3) define a width for the blending zone; (4) define a width for the peripheral stabilisation zone; (5) define a rotationally symmetric back surface for the contact lens; (6) select a plurality of half-meridians to define the front surface of the contact lens; (7) calculate a power profile along each of the plurality of half-meridians of the contact lens based on a prescription including a sphere power, a cylinder power, a cylinder axis and a spherical aberration; (8) select a lens material and a suitable centre thickness for the contact lens; (9) based on the lens material's refractive index and the centre thickness, calculate the radial or axial thickness profiles along each of the plurality of half-meridians within the optic zone to achieve the power profile, wherein the radial thickness profiles are defined with a plurality of discrete points selected along each of the plurality of the half-meridians within the optic zone; (10) add a desired thickness profile to each of the plurality of half-meridians within the peripheral stabilisation zone to provide a prism ballast; (11) optimise the blending width between the optic zone and the peripheral stabilisation zone for each of the plurality of the half meridians; (12) apply a suitable blending algorithm to join the optic zone and the peripheral zones such that they are substantially smooth along each of the plurality of half meridians; (13) add the thickness profiles along each of the plurality of half meridians onto the back surface to obtain the front surface data points; (14) add an edge to the front and back surface profile; and (15) transform the front and back surface data points into a format that is suitable for manufacturing the front and back surfaces.

In some other embodiments, the front surface toric soft contact lens may be configured such that the shape of the optic zone is substantially circular, and the shape may be independent of the magnitude of the sphere power, the cylinder power, the cylinder axis, or the spherical aberration of the prescription.

In some other embodiments, the front surface toric soft contact lens may be configured such that the toric optical correction of the optic zone of the contact lens has two different target powers along two orientations that are non-perpendicular to one another.

In other embodiments, the front surface toric soft contact lens may be defined using a rotationally symmetric back surface that may be designed as a single-curve asphere or a multicurve set of aspheres.

In another exemplary embodiment, the front surface toric soft contact lens of the disclosure may be defined using a plurality of half meridians; wherein the number of the plurality of half meridians may be between 12 and 400 or between 8 and 240.

In one example, the front surface toric soft contact lens may have a sphere power that is between −10 D and +10 D, the cylinder power that is between −0.5 DC and −3.5 DC, the cylinder axis that is between 0 and 180 degrees and the spherical aberration that is between −2 D and +2 D defined over the optic zone.

In another example, the front surface toric soft contact lens of the disclosure is produced in a lens material with a refractive index that is between 1.38 and 1.5. In another example, the front surface toric soft contact lens of the disclosure has a diameter that is between 13.5 mm and 15 mm. In another example, the front surface toric soft contact lens of the disclosure has an optic zone diameter that is between 6 and 9 mm.

In another example, the front surface toric soft contact lens of the disclosure is designed using a number of the plurality of discrete points of the density selected along each of the plurality of the half meridians wherein the number of plurality of discrete points is at least 100 or at least 1000 or is between 32 and 256 or is between 256 and 10000.

In another example, the front surface toric soft contact lens of the disclosure is defined with a rounded edge, chisel-edge, or a knife-edge.

Few other exemplary embodiments are described in the following examples sets.

### Example Set A: Front Surface Toric Soft Contact Lens for the Correction of Distance Vision

A front surface toric soft contact lens comprising a front surface, a back surface, a centre thickness, a front surface optic zone with a plurality of half-meridians and a plurality of power profiles, a peripheral stabilisation zone circumscribing the optic zone, a blending zone between the front optic zone and the peripheral stabilisation zone, and an edge; wherein the multifocal front surface toric soft contact lens is configured utilising a design method; wherein the design method utilises an algorithm that includes, at least in part, a series of design steps: (1) define a diameter for the front surface toric soft contact lens; (2) define diameters for the optic zones; (3) define a width for the blending zone for each half-meridian; (4) define a width for the peripheral stabilisation zone for each half-meridian; (5) define a rotationally symmetric back surface for the multifocal front surface toric soft contact lens; (6) select a plurality of half-meridians to define the multifocal front surface of the contact lens; (7) calculate a power profile along each of the plurality of half-meridians of the multifocal front surface toric soft contact lens based on a prescription including a sphere power, a cylinder power, a cylinder axis and a spherical aberration; (8) select a lens material and a suitable centre thickness for the front surface toric soft contact lens; (9) based on the lens material's refractive index and the centre thickness, calculate the radial or axial thickness profiles along each of the plurality of half-meridians within the optic zone to achieve the power profile, wherein the radial thickness profiles are defined with a plurality of discrete points selected along each of the plurality of the half-meridians within the optic zone; (10) add a desired thickness profile to each of the plurality of half-meridians within the peripheral stabilisation zone; (11) optimise the blending width between the optic zone and the peripheral stabilisation zone for each of the plurality of the half meridians; (12) apply a suitable blending algorithm to join the optic zone and the peripheral zones such that they are substantially smooth along each of the plurality of half-meridians; (13) add the thickness profiles along each of the plurality of half-meridians onto the back surface to obtain the front surface data points; (14) add an edge to the front and back surface profile; and (15) transform the front and back surface data points into a format that is suitable for manufacturing the front and back surfaces.

A front surface toric soft contact lens of claim 1 of the example set A, wherein the power profile along each of the plurality of half-meridians results in a front surface toric soft contact lens for the correction of distance vision.

A front surface toric soft contact lens of claim 1 of the example set A; wherein the shape of the optic zone is substantially circular, and the shape is independent of the magnitude of the sphere power, the cylinder power, the Add power, the cylinder axis, or the spherical aberration of the prescription.

A front surface toric soft contact lens of claim 1 of the example set A; wherein the rotationally symmetric back surface is designed as a single-curve asphere.

A front surface toric soft contact lens of claim 1 of the example set A; wherein the rotationally symmetric back surface is designed as a multicurve set of aspheres.

A front surface toric soft contact lens of claim 1 of the example set A; wherein the number of the plurality of half-meridians is between 12 and 400.

A front surface toric soft contact lens of claim 1 of the example set A; wherein the number of the plurality of half meridians is between 8 and 240.

A front surface toric soft contact lens of claim 1 of the example set A; wherein the sphere power is between −10 D and +10 D, the cylinder power is between −0.5 DC and −3.5 DC, the cylinder axis is between 0 and 180 degrees, and the spherical aberration is between −2 D and +2 D defined over the optic zone.

A front surface toric soft contact lens of claim 1 of the example set A; wherein

the lens material's refractive index is between 1.38 and 1.5.

A front surface toric soft contact lens of claim 1 of the example set A; wherein the diameter of the lens is between 13.5 mm and 15 mm.

A front surface toric soft contact lens of claim 1 of the example set A; wherein the circular optic zone diameter is between 6 and 9 mm.

A front surface toric soft contact lens of claim 1 of the example set A; wherein the number of the plurality of discrete points of the density selected along each of the plurality of the half meridians is at least 100.

A front surface toric soft contact lens of claim 1 of the example set A; wherein the number of the plurality of discrete points of the density selected along each of the plurality of the half meridians is between 32 and 256.

A front surface toric soft contact lens of claim 1 of the example set A; wherein the number of the plurality of discrete points of the density selected along each of the plurality of the half meridians is between 256 and 10000.

A front surface toric soft contact lens of claim 1 of the example set A; wherein the edge is defined as a rounded edge.

A front surface toric soft contact lens of claim 1 of the example set A; wherein

the edge is defined as chisel-edge.

A front surface toric soft contact lens of claim 1 of the example set A; wherein the edge is defined as a knife-edge.

A front surface toric soft contact lens of claim 1 of the example set A; wherein the axial thickness profiles along each of the plurality of half-meridians within the optic zone are used to achieve the power profile.

### Example Set B: Multifocal Front Surface Toric Soft Contact Lens

A multifocal front surface toric soft contact lens comprising a front surface, a back surface, a centre thickness, a front surface optic zone with a plurality of half-meridians and a plurality of power profiles, a peripheral stabilisation zone circumscribing the optic zone, a blending zone between the front optic zone and the peripheral stabilisation zone, and an edge; wherein the multifocal front surface toric soft contact lens is configured utilising a design method; wherein the design method utilises an algorithm that includes, at least in part, a series of design steps: (1) define a diameter for the multifocal front surface toric soft contact lens; (2) define diameters for the optic zones; (3) define a width for the blending zone for each half-meridian; (4) define a width for the peripheral stabilisation zone for each half-meridian; (5) define a rotationally symmetric back surface for the multifocal front surface toric soft contact lens; (6) select a plurality of half-meridians to define the multifocal front surface of the contact lens; (7) calculate a power profile along each of the plurality of half-meridians of the multifocal front surface toric soft contact lens based on a prescription including a sphere power, a cylinder power, an Add power, a cylinder axis and a spherical aberration; (8) select a lens material and a suitable centre thickness for the front surface toric soft contact lens; (9) based on the lens material's refractive index and the centre thickness, calculate the radial or axial thickness profiles along each of the plurality of half-meridians within the optic zone to achieve the power profile, wherein the radial thickness profiles are defined with a plurality of discrete points selected along each of the plurality of the half-meridians within the optic zone; (10) add a desired thickness profile to each of the plurality of half-meridians within the peripheral stabilisation zone; (11) optimise the blending width between the optic zone and the peripheral stabilisation zone for each of the plurality of the half meridians; (12) apply a suitable blending algorithm to join the optic zone and the peripheral zones such that they are substantially smooth along each of the plurality of half-meridians; (13) add the thickness profiles along each of the plurality of half-meridians onto the back surface to obtain the front surface data points; (14) add an edge to the front and back surface profile; and (15) transform the front and back surface data points into a format that is suitable for manufacturing the front and back surfaces.

A multifocal front surface toric soft contact lens of claim 1 of the example set B, wherein the power profile along each of the plurality of half-meridians results in a centre-near multifocal front surface toric soft contact lens.

A multifocal front surface toric soft contact lens of claim 1 of the example set B, wherein the power profile along each of the plurality of half-meridians results in a centre-distance multifocal front surface toric soft contact lens.

A multifocal front surface toric soft contact lens of one or more of the claims of example set B; wherein the shape of the optic zone is substantially circular, and the shape is independent of the magnitude of the sphere power, the cylinder power, the Add power, the cylinder axis, or the spherical aberration of the prescription.

A multifocal front surface toric soft contact lens of one or more of the claims of example set B; wherein the rotationally symmetric back surface is designed as a single-curve asphere.

A multifocal front surface toric soft contact lens of one or more of the claims of example set B; wherein the rotationally symmetric back surface is designed as a multicurve set of aspheres.

A multifocal front surface toric soft contact lens of one or more of the claims of example set B; wherein the number of the plurality of half-meridians is between 12 and 400.

A multifocal front surface toric soft contact lens of one or more of the claims of example set B; wherein the number of the plurality of half meridians is between 8 and 240.

A multifocal front surface toric soft contact lens of one or more of the claims of example set B; wherein the sphere power is between −10 D and +10 D, the cylinder power is between −0.5 DC and −3.5 DC, the cylinder axis is between 0 and 180 degrees, the Add power is between +0.5 and +3.5 D and the spherical aberration is between −2 D and +2 D defined over the optic zone.

A multifocal front surface toric soft contact lens of one or more of the claims of example set B; wherein the lens material's refractive index is between 1.38 and 1.5.

A multifocal front surface toric soft contact lens of one or more of the claims of example set B; wherein the diameter of the lens is between 13.5 mm and 15 mm.

A multifocal front surface toric soft contact lens of one or more of the claims of example set B; wherein the circular optic zone diameter is between 6 and 9 mm.

A multifocal front surface toric soft contact lens of one or more of the claims of example set B; wherein the number of the plurality of discrete points of the density selected along each of the plurality of the half meridians is at least 100.

A multifocal front surface toric soft contact lens of one or more of the claims of example set B; wherein the number of the plurality of discrete points of the density selected along each of the plurality of the half meridians is between 32 and 256.

A multifocal front surface toric soft contact lens of one or more of the claims of example set B; wherein the number of the plurality of discrete points of the density selected along each of the plurality of the half meridians is between 256 and 10000.

A multifocal front surface toric soft contact lens of one or more of the claims of example set B; wherein the edge is defined as a rounded edge.

A multifocal front surface toric soft contact lens of one or more of the claims of example set B; wherein the edge is defined as chisel-edge.

A multifocal front surface toric soft contact lens of one or more of the claims of example set B; wherein the edge is defined as a knife-edge.

A multifocal front surface toric soft contact lens of one or more of the claims of example set B; wherein the axial thickness profiles along each of the plurality of half-meridians within the optic zone are used to achieve the power profile.

1. A front surface toric soft contact lens comprising a front surface, a back surface, a centre thickness, a front surface optic zone with a plurality of half-meridians and a plurality of power profiles, a peripheral stabilisation zone circumscribing the optic zone, a blending zone between the front optic zone and the peripheral stabilisation zone, and an edge; wherein the front surface toric soft contact lens is configured utilising a design method; wherein the design method utilises an algorithm that includes, at least in part, a series of design steps: (1) define a diameter for the front surface toric soft contact lens; (2) define diameters for the optic zones; (3) define a width for the blending zone for each half-meridian; (4) define a width for the peripheral stabilisation zone for each half-meridian; (5) define a rotationally symmetric back surface for the front surface toric soft contact lens; (6) select a plurality of half-meridians to define the front surface of the contact lens; (7) calculate a power profile along each of the plurality of half-meridians of the front surface toric soft contact lens based on a prescription including a sphere power, a cylinder power, a cylinder axis and a spherical aberration; (8) select a lens material and a suitable centre thickness for the front surface toric soft contact lens; (9) based on the lens material's refractive index and the centre thickness, calculate the radial or axial thickness profiles along each of the plurality of half-meridians within the optic zone to achieve the power profile, wherein the radial thickness profiles are defined with a plurality of discrete points selected along each of the plurality of the half-meridians within the optic zone; (10) add a desired thickness profile to each of the plurality of half-meridians within the peripheral stabilisation zone; (11) optimise the blending width between the optic zone and the peripheral stabilisation zone for each of the plurality of the half meridians; (12) apply a suitable blending algorithm to join the optic zone and the peripheral zones such that they are substantially smooth along each of the plurality of half-meridians; (13) add the thickness profiles along each of the plurality of half-meridians onto the back surface to obtain the front surface data points; (14) add an edge to the front and back surface profile; and (15) transform the front and back surface data points into a format that is suitable for manufacturing the front and back surfaces.

2. The front surface toric soft contact lens of claim 1, wherein the shape of the optic zone is substantially circular, and the shape is independent of the magnitude of the sphere power, the cylinder power, the cylinder axis, or the spherical aberration of the prescription.

3. The front surface toric soft contact lens of claim 1, wherein the rotationally symmetric back surface is designed as a single-curve asphere.

4. The front surface toric soft contact lens of claim 1, wherein the rotationally symmetric back surface is designed as a multicurve set of aspheres.

5. The front surface toric soft contact lens of claim 1, wherein the number of the plurality of half-meridians is between 12 and 400.

6. The front surface toric soft contact lens of claim 1, wherein the number of the plurality of half meridians is between 8 and 240.

7. The front surface toric soft contact lens of claim 1, wherein the sphere power is between −10 D and +10 D, the cylinder power is between −0.5 DC and −3.5 DC, the cylinder axis is between 0 and 180 degrees and the spherical aberration is between −2 D and +2 D defined over the optic zone.

8. The front surface toric soft contact lens of claim 1, wherein the lens material's refractive index is between 1.38 and 1.5.

9. The front surface toric soft contact lens of claim 1, wherein the diameter of the lens is between 13.5 mm and 15 mm.

10. The front surface toric soft contact lens of claim 1, wherein the circular optic zone diameter is between 6 and 9 mm.

11. The front surface toric soft contact lens of claim 1, wherein the number of the plurality of discrete points of the density selected along each of the plurality of the half meridians is at least 100.

12. The front surface toric soft contact lens of claim 1, wherein the number of the plurality of discrete points of the density selected along each of the plurality of the half meridians is between 32 and 256.

13. The front surface toric soft contact lens of claim 1, wherein the number of the plurality of discrete points of the density selected along each of the plurality of the half meridians is between 256 and 10000.

14. The front surface toric soft contact lens of claim 1, wherein the edge is defined as a rounded edge.

15. The front surface toric soft contact lens of claim 1, wherein the edge is defined as chisel-edge.

16. The front surface toric soft contact lens of claim 1, wherein the edge is defined as a knife-edge.

17. The front surface toric soft contact lens of claim 1, wherein the axial thickness profiles along each of the plurality of half-meridians within the optic zone are used to achieve the power profile.

18. The front surface toric soft contact lens of claim 2, wherein the rotationally symmetric back surface is designed as a single-curve asphere.

19. The front surface toric soft contact lens of claim 2, wherein the rotationally symmetric back surface is designed as a multicurve set of aspheres.

20. The front surface toric soft contact lens of claim 2, wherein the number of the plurality of half-meridians is between 12 and 400.
